(19) United States
(12) Patent Application Publication
(10) Pub. No.: US 2022/0116204 A1
(43) Pub. Date: Apr. 14, 2022

(54) PROBABILISTIC SHARED SECRET VALIDATION

(71) Applicant: BRITISH TELECOMMUNICATIONS PUBLIC LIMITED COMPANY, LONDON (GB)

(72) Inventor: Jonathan ROSCOE, London (GB)

(21) Appl. No.: 17/310,016

(22) PCT Filed: Dec. 18, 2019
(86) PCT No.: PCT/EP2019/085914

§ 371 Date: Jul. 9, 2021

(30) Foreign Application Priority Data
Jan. 9, 2019 (EP) 19150866.2

(51) Int. Cl. H04L 9/08; G06F 16/22; H04L 9/06

(52) U.S. Cl. CPC H04L 9/085; G06F 16/2228; H04L 2209/38; H04L 9/0872; H04L 9/0643

(57) ABSTRACT

Systems and methods of shared secret validation for a transaction to transfer an association of a digital asset represented in a distributed transactional database from an incumbent entity to a requesting entity, the digital asset having associated a probabilistic data structure encoding at least one digital hash of each of a plurality of secrets including the shared secret, and the transaction including a hash of the shared secret, including validating the transaction by comparing the hash of the shared secret in the transaction with the probabilistic data structure; and responsive to the validation, committing the transaction in the database to effect the transfer of association of the digital asset to the requesting entity.

### PRIORITY CLAIM

The present application is a National Phase entry of PCT Application No. PCT/EP2019/085914, filed Dec. 18, 2019, which claims priority from EP Application No. 19150866.2, filed Jan. 9, 2019, which is hereby fully incorporated herein by reference.

### TECHNICAL FIELD

The present disclosure relates to the validation of shared secrets between entities.

### BACKGROUND

Digital assets are increasingly employed to represent resources used in the delivery of services to service consumers such as end-users. For example, telephone numbers in telephony services, metering point identifiers in energy and utility supply services, unique addresses in data communication services, customer hostnames and/or addresses in network hosting services and other assets as will be apparent to those skilled in the art.

The ability for a consumer, user or serviced entity to retain a resource represented by such a digital asset while changing service provider is increasingly desirable. For example, telephony consumers desire to retain a telephone number even when changing service provider. In some contexts, retention of a resource is required to avoid replacement of physical infrastructure, such as a metering point in an energy supply service which can be employed by a number of different service providers.

Management of such resources as digital assets requires mechanisms for transferring digital assets between entities such as service providers, and such transfers must be checked for authenticity to avoid fraudulent, malicious or erroneous transfers taking place. For example, as part of a transfer of a telephone number between telephony service providers, authenticity of the transfer request and its origin must be verifiable. Such verification requires the confirmation that a new requesting service provider and an existing incumbent service provider share some secret(s), such as secrets relating to a consumer entity. This requires transfer of secret information therebetween and introduces challenges of privacy and security of such information.

It is therefore desirable to address these challenges while providing for the transfer of digital assets representing resources used in the provision of services.

### SUMMARY

The present disclosure accordingly provides a computer implemented method of shared secret validation for a transaction to transfer an association of a digital asset represented in a distributed transactional database from an incumbent entity to a requesting entity, the digital asset having associated a probabilistic data structure encoding at least one digital hash of each of a plurality of secrets including the shared secret, and the transaction including a hash of the shared secret, the method comprising: validating the transaction by comparing the hash of the shared secret in the transaction with the probabilistic data structure; and responsive to the validating, committing the transaction in the database to effect the transfer of association of the digital asset to the requesting entity.

In an embodiment, the probabilistic data structure is a Bloom filter.

In an embodiment, the transaction is validated by confirming the hash of the shared secret in the transaction is encoded in the probabilistic data structure.

In an embodiment, the method further comprises, in response to a determination that the hash in the transaction is inconsistent with the secrets encoded in the probabilistic data structure, rejecting the transaction.

In an embodiment, the method further comprises receiving an indication from the incumbent entity that the hash in the transaction is invalid and committing a second transaction to the database to reverse the transfer of association of the digital asset such that the digital asset is re-associated with the incumbent entity.

In an embodiment, the digital asset is an identifier of a resource used in the provision of a service, the service being providable separately by service provider entities corresponding to each of the incumbent and requesting entities, and association of an entity corresponding to a service provider entity with the digital asset permits provision of the service using the resource by the service provider entity.

In an embodiment, the digital asset is a telephone number and each of the incumbent and requesting entities correspond to telephony service providers, the association of the telephone number with an entity corresponding to a telephony service provider permitting the provision of telephony services by the telephony service provider using the telephone number.

In an embodiment, the plurality of secrets includes one or more of: personal information; private information; an address indication; a geographic location; a postal code; a password; and a key.

In an embodiment, the distributed transactional database is a blockchain.

The present disclosure accordingly provides a computer system including a processor and memory storing computer program code for performing the steps of the method set out above.

The present disclosure accordingly provides a computer program element comprising computer program code to, when loaded into a computer system and executed thereon, cause the computer to perform the steps of the method set out above.

### BRIEF DESCRIPTION OF THE DRAWINGS

Embodiments of the present disclosure will now be described, by way of example only, with reference to the accompanying drawings, in which:

FIG. 1 is a block diagram of a computer system suitable for the operation of embodiments of the present disclosure;

FIG. 2 is a component diagram of an arrangement for shared secret validation in the transfer of association of a digital asset between entities in accordance with an embodiment of the present disclosure;

FIG. 3 is a flowchart of a method of shared secret validation in accordance with embodiments of the present disclosure; and

FIG. 4 depicts an exemplary simplified probabilistic data structure in embodiments of the present disclosure; and

FIGS. 5a, 5b, and 5c depict exemplary hashed secrets in transactions from requesting entities in accordance with embodiments of the present disclosure.

### DETAILED DESCRIPTION OF EMBODIMENTS

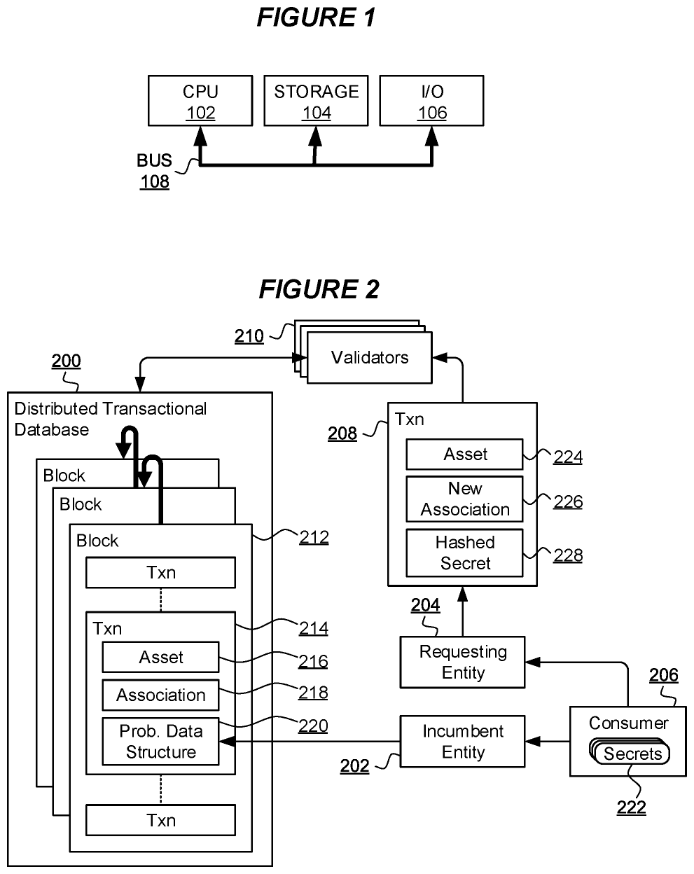

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for shared secret validation in the transfer of association of a digital asset 216 between entities in accordance with an embodiment of the present disclosure. The digital asset 216 is an asset or representation of an asset used in the provision of a service, such as a utility, telephony, other communications or other service as will be apparent to those skilled in the art. For example, the digital asset 216 can be a telephone number or the like. The asset 216 is associated with an entity corresponding to a service provider for providing the service to a consumer 206. This entity is the incumbent entity 202 because the entity corresponds to a current incumbent service provider. The association between the incumbent entity 202 and the digital asset 216 is indicated by way of one or more transactions 214 in a distributed transactional database 200. For example, a transaction 214 includes an indication or representation of the asset, a data structure representing the asset, or the asset itself 216. Additionally, the transaction 214 includes an indication of the incumbent entity 202 associated with the asset by way of an association 218 or other suitable association means. The transaction 214 further includes a probabilistic data structure 220 such as a Bloom filter as is described below.

In an embodiment, the transaction 214 existing among a plurality of transactions within blocks 212 of a blockchain data structure as a distributed transactional database. Transactional databases are increasingly used to provide records of transactions occurring between entities such as computer systems or digital representations of physical entities such as service providers and the like. For example, a blockchain database or data structure is a sequential transactional database that may be distributed and is communicatively connected to a network. Such transactional databases in the field of cryptocurrencies are documented, for example, in “Mastering Bitcoin. Unlocking Digital Crypto-Currencies.” (Andreas M. Antonopoulos, O'Reilly Media, April 2014). For convenience, such a database is herein referred to as a distributed transactional database though other suitable databases, data structures or mechanisms possessing the characteristics of a distributed transactional database, such as a blockchain, can be treated similarly. A distributed transactional database provides a distributed chain of data structures (commonly known as blocks 212) accessed by a network of nodes known as a network of miners or validators 210. Each block 212 in the database includes one or more transaction data structures 214. In some distributed transactional database, such as the BitCoin blockchain, the database includes a Merkle tree of hash or digest values for transactions included in a block to arrive at a hash value for the block, which is itself combined with a hash value for a preceding block to generate a chain of blocks (blockchain). A new block of transactions is added to the database by validator 210 software, hardware, firmware or combination components in a miner network of validators 210. Validators 210 are hardware, software, firmware or combination components communicatively connected to sources of transactions and access or copy the database 200. A validator 210 undertakes validation of a substantive content of a transaction (such as criteria and/or executable code included therein) and adds a block 212 of new transactions to the database 200 when, for example, a challenge is satisfied, typically such challenge involving a combination hash or digest for a prospective new block and a preceding block in the database and some challenge criterion. Thus, validators 210 in the miner network may each generate prospective new blocks for addition to the database 200. Where a validator 210 satisfies or solves the challenge and validates the transactions in a prospective new block, such new block is added to the database 200. Accordingly, the database provides a distributed mechanism for reliably verifying a data entity such as an entity constituting or representing the potential to consume a resource.

While the detailed operation of distributed transactional databases and the function of validators in the miner network is beyond the scope of this specification, the manner in which the database and network of miners operate is intended to ensure that only valid transactions are added within blocks to the database 200 in a manner that is persistent within the database. Transactions added erroneously or maliciously should not be verifiable by other validators 210 in the network and should not persist in the database. This attribute of distributed transactional database is exploited by applications of such databases and miner networks such as cryptocurrency systems in which currency amounts are expendable in a reliable, auditable, verifiable way without repudiation.

The probabilistic data structure 220 is a data structure consisting of one or more data items suitable for determining whether a given element is a member of a dataset or not. Thus, the probabilistic data structure 220 encodes data items. In particular, the probabilistic data structure 220 encodes data items in a manner such that the data items cannot be determined or extracted from the data structure 220 by encoding a hash of each data item. The probabilistic data structure 220 can be used to determine if a particular data item is encoded by the data structure 220 by comparing a hash of the data item with the data structure 220.

In an embodiment, the probabilistic data structure 220 is a Bloom filter such as a bit array of elements in which hashed data items are represented by setting bits in the array in dependence on a value of the hash for each data item. In some embodiments, multiple hashing algorithms can be employed for each data item encoded in the array such that a single item is encoded multiple times in the array. In an embodiment, hashing functions used to generate hash values for data items are independent and uniformly distributed. In an embodiment, hash functions are relatively high performance so that hash values can be evaluated quickly and efficiently. Thus, in an embodiment, complex hash functions such as those used in some cryptographic algorithms are not used.

In use, the probabilistic data structure 220 encodes secrets 222 associated with a consumer 206 to which services are provided by a service provider represented by the incumbent entity 202. For example, in the provision of a telephony service, the consumer 206 can be a telephony service user and the secrets 222 can be personal information associated with the consumer 206. Notably, while the secrets 222 are described as secret as such, they are not necessarily confidential information and may constitute personal, private or sensitive information associated with the consumer 206 such that they are shared with service providers such as the incumbent entity 202 but are, in an embodiment, not distributed widely. For example, the secrets 222 may constitute highly sensitive information in combination, whereas individual secrets themselves may not be so sensitive or secret at all. For example, a name, address and postcode of a consumer 206 each individually constitute personal information. In combination, these pieces of personal information increase in sensitivity and are to be treated as secrets 222 for the consumer to protect against, for example, identity theft, fraud, misuse of information and other threats. Thus, secrets 222 can include data items corresponding to, for example, personal information, private information, address indications, geographic location(s), postal code, zip code, password, key and other data items as will be apparent to those skilled in the art.

At least a subset of the secrets 222 are encoded in the probabilistic data structure 220 by, for example, the incumbent entity 202. The incumbent entity 202 can also store or has access to original data items for the secrets 222. Thus the transaction 214 in the distributed transactional database 200 serves to associate a digital asset 216 with the incumbent entity 202 and encodes secrets of a consumer for service provision using resource(s) identified or represented by the digital asset 216. While the probabilistic data structure 220 is indicated as being stored within a transaction in the distributed transactional database 200 it will be apparent to those skilled in the art that the data structure 220 could alternatively be provided elsewhere, including in another database or transaction, with an association between the asset 216 and the probabilistic data structure 220 being provided in, for example, the transaction 214.

The arrangement of FIG. 2 further includes a requesting entity 204 as an entity representing a service provider requesting to transfer the association of the digital asset 216 from the incumbent entity 202 to the requesting entity 204. For example, the requesting entity 204 can correspond to a telephony service provider requesting transfer of the digital asset 216 representing a telephone number from an incumbent telephony service provider corresponding to incumbent entity 202 to itself. To effect the change in association of the digital asset 216 it is necessary for the requesting entity 204 to demonstrate that the transfer of association of the asset 216 to the requesting entity 204 is sanctioned by the consumer 206. Embodiments of the present disclosure provide for verification of this sanctioning of the transfer of association of the digital asset 216 without a requirement for the sharing, publication or distribution of secrets of the consumer 222 other than between the consumer 222 itself and each of the requesting 204 and incumbent 202 entities themselves. In this way, the disclosure of the secrets 222 of the consumer 206 can be restricted to the service providers and their corresponding entities 202, 204.

The requesting entity 204 generates a new transaction 208 intended to effect a transfer of association of the digital asset 216 from the incumbent entity 202 to the requesting entity 204. The new transaction 208 includes: an identification of the asset 224, such as a unique asset reference or a copy of the digital asset itself; an identification of a new association 226 that is to be formed between the digital asset 216 and the requesting entity 204; and at least one hashed secret 228. The hashed secret 228 is a hash of a secret 222 of the consumer 206 hashed using the hashing algorithm(s) employed in the generation of the probabilistic data structure 220. The new transaction 208 is received by validators 210 in the miner network to validate and commit the transaction to the distributed transactional database 200.

The validators 210 (and, indeed, everyone) can determine if the hashed secret 228 is encoded in the probabilistic data structure 220 by comparing the hashed secret 228 with the data structure 220. Notably, the nature of probabilistic data structures 220 such as Bloom filters is that they are able to confirm with certainty if a data item is not encoded in the data structure, and can confirm with a degree of certainty (less than absolute certainty) if an item is encoded in the data structure. Thus, the dimensions, hashing algorithms and number of secrets encoded in the probabilistic data structure 220 can be arranged to increase a suitability of the data structure 220 for delivering positive indications that data items are encoded therein with greater degrees of reliability as will be apparent to those skilled in the art.

Thus, in use, where at least one of the validators 210 determine, with at least a predetermined degree of certainty, that the hashed secret 228 does correspond to a data item encoded by the probabilistic data structure 220, the transaction 208 effecting a transfer of association of the digital asset 216 to the requesting entity 204 is committed to the database 200. In contrast, where a validator 210 determines that the hashed secret 228 is not encoded by the probabilistic data structure 220, the new transaction 208 is rejected.

The committing of the new transaction 208 can be sufficient to achieve the transfer of association of the digital asset 214 to the requesting entity 204 in systems where the distributed transactional database 200 serves to define a prevailing state of such associations. Thus, a blockchain, for example, used to indicate which telephony service providers are providing telephony services for which telephone numbers can be adjusted using the methods described herein. Notably, the transfer is effected and validated without distribution or publication of consumer secrets 222.

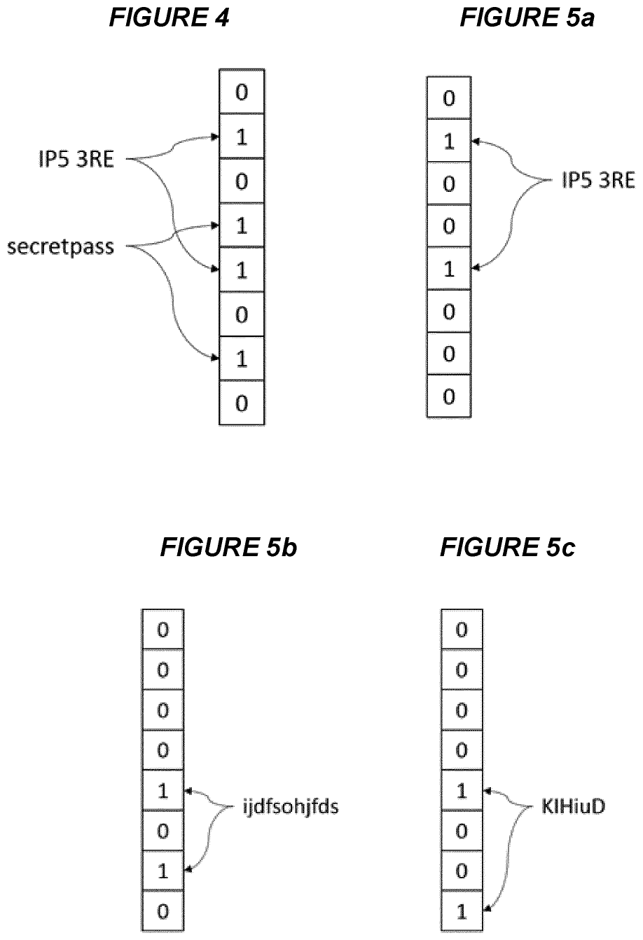

While the validators 210 can determine whether the hashed secret 228 in the prospective new transaction 208 is encoded in the probabilistic data structure 220 with a degree of certainty, the incumbent entity 202 may be in a position to make such a determination with an even greater degree of certainty. To demonstrate this, refer, for example, to the Bloom filter representation of FIG. 4 and the exemplary hashed secrets of FIGS. 5a, 5b and 5c. FIG. 4 depicts an exemplary simplified probabilistic data structure 200 in embodiments of the present disclosure. In FIG. 4, two secrets 222 of the consumer 206 are encoded in a simplified Bloom filter. In the example of FIG. 4, a postal code of “IP5 3RE” and a password of “secretpass” are encoded to arrive at a bit array “01011010” accordingly. Subsequently, a proposed new transaction 208 generated by the requesting entity 204 includes hashed secrets such as those indicated in FIGS. 5a, 5b and 5c. FIGS. 5a, 5b and 5c depict exemplary hashed secrets in transactions from requesting entities in accordance with embodiments of the present disclosure. The hashed secret of FIG. 5a is generated based on a postcode “IPS 3RE” which, when hashed, are indicated in bit positions in a Bloom filter. The bits set in the Bloom filter of FIG. 5a are consistent with bits set in the Bloom filter of FIG. 4 and the hashed secret of FIG. 5a can be determined to be consistent with data encoded in the Bloom filter of FIG. 4. Notably, this determination can be validated by anyone with visibility of the hashed secret 228 and the Bloom filter 220.

In contrast, FIG. 5b illustrates a Bloom filter generated to represent a hashed secret that is not consistent with those secrets encoded in the Bloom filter of FIG. 4. The data item of FIG. 5b nonetheless indicates bit positions having bits set that are set in the Bloom filter of FIG. 4. Thus, validators 210 can conclude that the hashed secret of FIG. 5b is consistent with data encoded in the Bloom filter of FIG. 4 and a transaction including such hashed secret would be committed to the database 200. While inspection and comparison of the Bloom filter of FIG. 4 and the hashed data item of FIG. 5b leads to such a conclusion, the incumbent entity 202 itself is able to determine that the representation of the hashed secret of FIG. 5b cannot be based on a real secret 222 of the consumer 206 because each bit set in the representation of FIG. 5b corresponds to a different secret in the Bloom filter of FIG. 4. Thus, while the validators commit a transaction on the basis of hashed data of FIG. 5b, the incumbent entity 202 identifies a failure of validation and determines that the transaction 208 of the requesting entity 204 is invalid. In this case, the incumbent entity 202 can issue a new transaction specifically reversing the committed transaction 208 of the requesting entity 204 to reverse the transfer of association of the digital asset 216 such that the digital asset is re-associated with the incumbent entity 202.

Referring now to FIG. 5c in which a hashed secret is indicated that does not correspond to the encoded data items in the Bloom filter of FIG. 4, validators 210 are able to conclude the hashed secret of FIG. 5c is not valid by comparison with the Bloom filter of FIG. 4 and a transaction citing such hashed secret of FIG. 5c will be rejected.

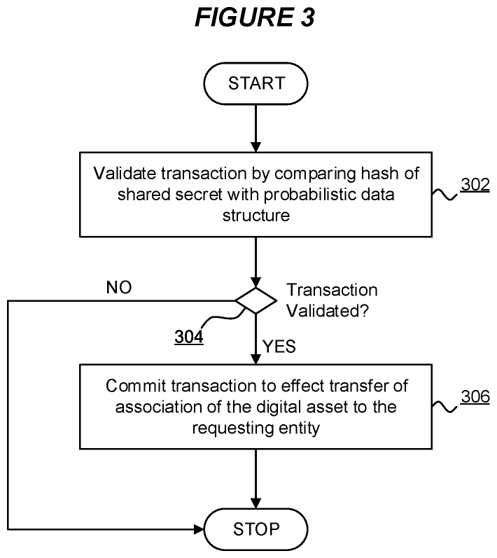

FIG. 3 is a flowchart of a method of shared secret validation in accordance with embodiments of the present disclosure. Initially, at step 302, a transaction 208 from a requesting entity 204 for transferring association of a digital asset 216 is validated by comparing a hash 228 of the shared secret in the transaction 208 with a probabilistic data structure 220 associated with the digital asset. Where the transaction 208 is determined to be validated at step 304, the validators 210 commit the transaction 208 in the distributed transactional database 200 to effect a transfer of association of the digital asset 216 to the requesting entity 204 (step 306).

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of shared secret validation for a transaction to transfer an association of a digital asset represented in a distributed transactional database from an incumbent entity to a requesting entity, the digital asset having associated a probabilistic data structure encoding at least one digital hash of each of a plurality of secrets including the shared secret, and the transaction including a hash of the shared secret, the method comprising:
validating the transaction by comparing the hash of the shared secret in the transaction with the probabilistic data structure; and
responsive to the validating, committing the transaction in the database to effect the transfer of association of the digital asset to the requesting entity.

2. The method of claim 1 wherein the probabilistic data structure is a Bloom filter.

3. The method of claim 1 wherein the transaction is validated by confirming the hash of the shared secret in the transaction is encoded in the probabilistic data structure.

4. The method of claim 1 further comprising, in response to a determination that the hash in the transaction is inconsistent with the secrets encoded in the probabilistic data structure, rejecting the transaction.

5. The method of claim 1 further comprising receiving an indication from the incumbent entity that the hash in the transaction is invalid and committing a second transaction to the database to reverse the transfer of association of the digital asset such that the digital asset is re-associated with the incumbent entity.

6. The method of claim 1 wherein the digital asset is an identifier of a resource used in the provision of a service, the service being providable separately by service provider entities corresponding to each of the incumbent and requesting entities, and association of an entity corresponding to a service provider entity with the digital asset permits provision of the service using the resource by the service provider entity.

7. The method of claim 1 in which the digital asset is a telephone number and each of the incumbent and requesting entities correspond to telephony service providers, the association of the telephone number with an entity corresponding to a telephony service provider permitting the provision of telephony services by the telephony service provider using the telephone number.

8. The method of claim 1 in which the plurality of secrets includes one or more of: personal information; private information; an address indication; a geographic location; a postal code; a password; and a key.

9. The method of claim 1 wherein the distributed transactional database is a blockchain.

10. A computer system including a processor and memory storing computer program code for performing the steps of the method of claim 1.

11. A computer program element comprising computer program code to, when loaded into a computer system and executed thereon, cause the computer to perform the steps of a method as claimed in claim 1.
